(19) United States
(12) Patent Application Publication
(10) Pub. No.: US 2014/0030525 A1
(43) Pub. Date: Jan. 30, 2014

(54) SILICON DIOXIDE POWDER HAVING LARGE PORE LENGTH

(71) Applicants: Frank Menzel, Hanau (DE); Michael Hagemann, Kahl (DE); Andreas Hille, Loerrach (DE); Arkadi Maisels, Hanau (DE)

(72) Inventors: Frank Menzel, Hanau (DE); Michael Hagemann, Kahl (DE); Andreas Hille, Loerrach (DE); Arkadi Maisels, Hanau (DE)

(73) Assignee: Evonik Degussa GmbH, Essen (DE)

(21) Appl. No.: 14/110,561

(22) PCT Filed: Feb. 21, 2012
(86) PCT No.: PCT/EP2012/052941

§ 371 Date: Oct. 8, 2013

(30) Foreign Application Priority Data
Apr. 27, 2011 (DE) 102011017587.3

(51) Int. Cl. C01B 33/03

(52) U.S. Cl. CPC C01B 33/03
USPC 428/402; 423/335; 423/337; 556/450

(57) ABSTRACT

Silicon dioxide powder in the form of aggregated primary particles has a specific pore length L of 2.5×10⁵ to 4×10⁵ m/μg, where L is defined as the quotient formed from the square of the BET surface area and the cumulative 2-50 nm pore volume determined using the BJH method, as per the formula L=(BET×BET)/BJH volume.

A silanized silicon dioxide powder in the form of aggregated primary particles has a specific pore length L of 2.5×10⁵ to 3.5×10⁵ m/μg, and in it the surface area of the aggregates or parts thereof is occupied by chemically bound silyl groups.

A thermal insulant comprises the silicon dioxide powder and/or the silanized silicon dioxide powder.

This invention relates to a silicon dioxide powder and a silanized silicon dioxide powder and their methods of making. The present invention further relates to a thermal insulant comprising these silicon dioxide powders.

The flame hydrolysis process for producing silicon dioxide has long been known and is practiced on a large industrial scale. In this process, a vaporized or gaseous hydrolyzable silicon halide is reacted with a flame formed by burning hydrogen and an oxygen-containing gas. This flame supplies water to hydrolyze the silicon halide and sufficient heat to drive the hydrolysis reaction. Silicon dioxide thus obtained is known as pyrogenous silicon dioxide.

This process initially generates primary particles which are nearly devoid of internal pores. These primary corpuscles fuse during the process—via so-called “sinter necks”—into aggregates which have an open three-dimensional structure and so are macroporous.

Owing to this structure, pyrogenically produced silicon dioxide powders are ideal thermal insulants, since the aggregate structure ensures sufficient mechanical stability, minimizes heat transfer by solid-state conductivity via the “sinter necks”, and creates a sufficiently high porosity. When thermal insulants comprising pyrogenous silicon dioxide are compression molded, moreover, the transfer of heat by convection is minimized.

The technical problem addressed by the present invention was that of providing a silicon dioxide powder which promises to have improved thermal insulation properties due to its structure. A further problem addressed by the present invention was that of providing a process for producing this silicon dioxide powder.

The present invention provides a silicon dioxide powder in the form of aggregated primary particles which has a specific pore length L of 2.5×10⁵ to 4×10⁵ m/μg, and preferably 2.8 to 3.5×10⁵ m/μg, where L is defined as the quotient formed from the square of the BET surface area and the cumulative 2-50 nm pore volume determined using the BJH method, as per the formula L=(BET×BET)/BJH volume.

The primary particle are very largely spherical, their surface is smooth and they have only a minimal number of micropores. They are firmly aggregated via sinter necks. The aggregates form open three-dimensional structures which determine the microporosity.

The powder of the present invention may be minimally contaminated with impurities due to the starting materials or the production process. The SiO₂ content is generally not less than 99% by weight and preferably not less than 99.5% by weight.

There is no limitation on the BET surface area of the silicon dioxide particles according to the present invention. The BET surface area is generally in the range from 200 m²/g to 1000 m²/g. The BET surface area of the silicon dioxide powder in one particular embodiment is in the range from 400 to 600 m²/g; a BET surface area of 450 to 550 m²/g may be particularly preferable.

It may further be advantageous for the cumulative 2-50 nm pore volume determined using the BJH method to have a value of 0.7 to 0.9 cm³/g and more preferably of 0.80 to 0.85 cm³/g for the silicon dioxide powder.

In a further embodiment of the present invention, the silicon dioxide powder has a t-plot micropore volume of 0.030 to 0.1 cm³/g, preferably 0.035 to 0.070 cm³/g.

Mean pore size of the silicon dioxide powder is preferably in the range from 6 to 9 nm. The D₅₀ median value of the frequency distribution of primary particle diameters is preferably in the range from 4 to 6 nm and the 90% span of the frequency distribution of primary particle diameters in the range from 1.5 to 15 nm.

The present invention further provides a process for producing the silicon dioxide powder of the present invention, characterized in that a gas mixture comprising an oxidizable and/or hydrolyzable silicon compound, hydrogen and an oxygen-containing gas 1, preferably air 1, is ignited in a burner and the flame is burned into a reaction chamber, oxygen-containing gas 2, preferably air 2, is additionally introduced into the reaction chamber, then the solid material obtained is optionally treated with water vapor and separated from gaseous materials, with the provisos that

a) in the burner
a quotient I formed from the supplied amount of oxygen and the stoichiometrically required amount of oxygen is in the range from 2 to 4, and
a quotient II formed from the supplied amount of hydrogen and the stoichiometrically required amount of hydrogen is in the range from 0.70 to 1.30, and
the exit velocity v of the gas mixture from the burner is in the range from 10 to 100 ms⁻¹ and preferably in the range from 30 to 60 ms⁻¹, and
   b) in the reaction space
a quotient III formed from total supplied amount of oxygen and stoichiometrically required amount of oxygen is in the range from 2 to 4, and
the quotient III/quotient I ratio is in the range from 1.1 to 1.5.

To obtain the silicon dioxide powder of the present invention it is essential to observe the feed quantities defined by the quotients and the ratio of said feed quantities together with a high exit velocity.

In one particular embodiment, the process according to the present invention is carried out such that

quotient I=2.20 to 3.00, more preferably 2.30 to 2.80,
quotient II=0.80 to 0.95, more preferably 0.85 to 0.90,
quotient III=2.50 to 3.80, more preferably 3.00 to 3.45, and v=30 to 60 ms⁻¹.

In a further embodiment,

quotient I=2.20 to 3.00, more preferably 2.30 to 2.80,
quotient II=1.00 to 1.30, more preferably 1.03 to 1.30,
quotient III=2.50 to 3.80, more preferably 3.00 to 3.45, and v=30 to 60 ms⁻¹.

The stoichiometrically required amount of oxygen is defined as the oxygen quantity needed to at least convert the silicon compounds into silicon dioxide and react any hydrogen still present.

The stoichiometrically required amount of hydrogen is defined as the hydrogen quantity needed to at least convert the chlorine in the silicon compounds into hydrogen chloride.

The silicon compound used may preferably be at least one from the group consisting of SiCl₄, CH₃SiCl₃, (CH₃)₂SiCl₂, (CH₃)₃SiCl, HSiCl₃, H₂SiCl₂ H₃SiCl (CH₃)₂HSiCl, CH₃C₂H₅SiCl₂, (n-C₃H₇)SiCl₃ and (H₃C)ₓCl₃₋ₓSiSi(CH₃)_{y}Cl_{3-y} where R═CH₃ and x+y=2 to 6. It may be particularly preferable to use SiCl₄ or a mixture of SiCl₄ and CH₃SiCl₃.

After separation from gaseous materials, the silicon dioxide powder can be treated with water vapor. The primary purpose of this treatment is to remove chloride-containing groups which, when chlorine-containing starting materials are used, may possibly adhere to the surface of the particles. At the same time, this treatment reduces the number of agglomerates. The process can be operated in the continuous mode by treating the powder with water vapor, optionally together with air, in co- or countercurrent. The temperature for the treatment with water vapor is between 250 and 750° C., values from 450 to 550° C. being preferred.

The present invention further provides a silanized silicon dioxide powder in the form of aggregated primary particles having a specific pore length L of 2×10⁵ to 3.5×10⁵ m/μg, preferably 2.5 to 3.2×10⁵ m/μg, where L is defined as the quotient formed from the square of the BET surface area and the cumulative 2-50 nm pore volume determined using the BJH method, as per the formula L=(BET×BET)/BJH volume, and wherein the surface area of the aggregates or parts thereof is occupied by chemically bound silyl groups, preferably linear and/or branched alkylsilyl groups and more preferably linear and/or branched alkylsilyl groups having 1 to 20 carbon atoms.

The specific surface area of the silanized silicon dioxide powder may preferably be more than 400 to 550 m²/g. The carbon content is generally in the range from 0.1% to 10% by weight and preferably in the range from 0.5% to 5% by weight, all based on the silanized silicon dioxide powder.

The present invention further provides a process for producing the silanized silicon dioxide powder wherein the silicon dioxide powder of the present invention is sprayed with one or more silanizing agents, optionally dissolved in an organic solvent, and the mixture is then treated thermally, preferably at a temperature of 120 to 400° C. for a period of 0.5 to 8 hours, optionally under a protective gas. The surface-modifying agent is preferably selected from the group consisting of hexamethyldisilazane, dimethyldimethoxysilane, dimethyldiethoxysilane, trimethylmethoxysilane, methyl-trimethoxysilane, butyltrimethoxysilane, dimethyl-dichlorosilane, trimethylchlorosilane and/or silicone oils.

The present invention further provides a thermal insulant comprising the silicon dioxide powder of the present invention and/or the silanized silicon dioxide powder. The thermal insulant may further comprise opacifiers and/or binders.

The present invention further provides for the use of the silicon dioxide powder or of the silanized silicon dioxide powder as a filler in rubber, silicone rubber and plastics, as a rheology modifier in coatings and paints, as a carrier for catalysts and as a constituent of ink-receiving media.

### EXAMPLES

### Analytical Determinations

BET surface area is determined according to DIN ISO 9277. BJH and t-plot methods are described in DIN 66134 and DIN 66135. The t-plot method employs the layer thickness equation

t=(26.6818/(0.0124806−log(p/p₀)))^{0.4}, where p=gas pressure and

p₀=saturation vapor pressure of the adsorptive at the measurement temperature, both in pascals (Pa).

Primary particle diameters are determined using a TGZ 3 particle size analyzer from Zeiss by analysis of TEM images recorded using an instrument from Hitachi (H 7500) and a CCD camera from SIS (MegaView II). Image enlargement for evaluation is 30 000:1 with a pixel density of 3.2 nm. About 10 000 particles are evaluated. Sample preparation is in accordance with ASTM 3849-89.

Example 1 112 kg/h of silicon tetrachloride are vaporized and carried with nitrogen into the mixing chamber of a burner. Concurrently, 35 m³(STP)/h of hydrogen and 190 m³(STP)/h of air 1 are introduced into the mixing chamber. The mixture is ignited and burned in a flame into a reaction chamber. The exit velocity from the burner is 53.0 ms⁻¹. Additionally 50 m³(STP)/h of air 2 are introduced into the reaction chamber. The reaction gases and the resultant silicon dioxide are sucked by an applied negative pressure through a cooling system and are cooled to values between 100 and 160° C. in the process. The solid material is separated from the off-gas stream in a filter or cyclone and subsequently treated with water vapor at a temperature of 560° C.

Example 2 is carried out similarly to Example 1 except that 30.7 m³(STP)/h of hydrogen and 168 m³(STP)/h of air 1 are introduced into the mixing chamber. Exit velocity from the burner is 47.2 ms⁻¹.

Example 3 is carried out similarly to Example 1 except that 26 m³(STP)/h of hydrogen and 170 m³(STP)/h of air 1 are introduced into the mixing chamber. Exit velocity from the burner is 46.6 ms⁻¹.

Table 1 shows the starting materials used and values calculated therefrom. The physical-chemical values of the silicon dioxide powders obtained are shown in Table 2. The comparative examples are the commercially available silicon dioxide powders AEROSIL® 300 (C1) and AEROSIL® 380 (C2), both from Evonik Degussa; Cab-O-Sil® EH5 (C3), Cabot; REOLOSIL QS 30 (C4), Tokuyama and HDK® 40 (C5), Wacker.

Computation of quotients I-III will now be shown for Example 1. The underlying reaction equation is

SiCl₄+2H₂+O₂->SiO₂4HCl.

Thus, 2 mol of hydrogen and 1 mol of oxygen are required per mole of SiCl₄. 112.0 kg (0.659 kmol) of SiCl₄ are burned with 35 m³(STP) of hydrogen and 190 m³(STP) of air, corresponding to 39.9 m³(STP) of oxygen.

Accordingly, the stoichiometrically required amount of hydrogen is 2×0.659 kmol=1.318 kmol=29.54 m³(STP) of hydrogen. Hence quotient II is 35/29.54=1.18.

The stoichiometrically required amount of oxygen is made up of

fraction (a) required to form the silicon dioxide, and
fraction (b) required to convert excess hydrogen into water. The stoichiometrically required amount of oxygen for the above example is computed as follows:
fraction a): formation of SiO₂=0.659 kmol=14.77 m³(STP) of O₂
fraction b): H₂O from the hydrogen which did not react with SiCl₄:
m³(STP) of H₂−29.54 m³(STP) of H₂=5.46 m³(STP) of H₂ unconverted
H₂+0.5 O₂->H₂O requires 5.46/2=2.23 m³(STP) of O₂.
Stoichiometrically required amount of oxygen=fractions (a+=(14.77+2.23) m³(STP) of O₂=17 m³(STP) of O₂. Hence quotient I is (190*0.21) m³(STP) of O_{2 used/}17 m³(STP) of O_{2 required}=2.70.

Air is additionally introduced into the reaction chamber in the process according to the present invention. This does not change the stoichiometric oxygen requirement. Quotient III computes from the total introduced amount of oxygen, burner plus reaction space, as (190+50)*0.21 m³(STP) of O_{2used}./17 m³(STP) of O_{2required}=3.41, and the quotient III/I ratio computes as 1.26.

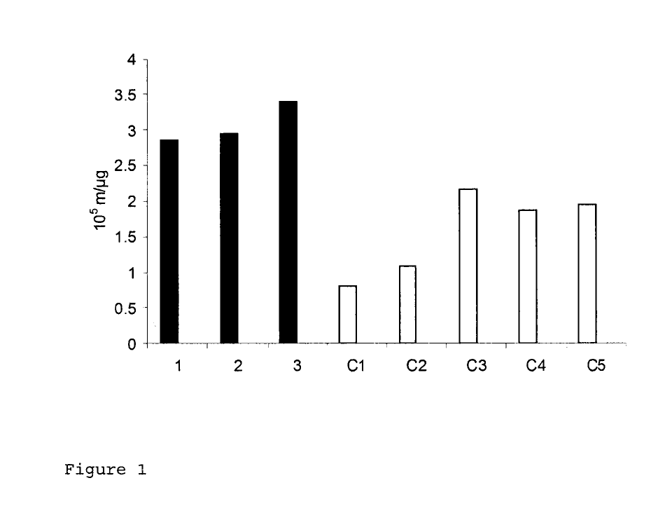

FIG. 1 shows the pore length of inventive silicon dioxide powders 1 to 3 and of comparative examples C1 to C5. The distinctly greater pore length of the silicon dioxide powders according to the present invention is apparent.

TABLE 1
Feed materials and usage conditions

| Example | | 1 | 2 | 3 |
|---|---|---|---|---|
| SiCl₄ | kg/h | 112.0 | 112.0 | 112.0 |
| H₂ | m³(STP)/h | 35.0 | 30.7 | 26.0 |
| air 1 | m³(STP)/h | 190.0 | 168.0 | 170.0 |
| air 2 | m³(STP)/h | 50.0 | 50.0 | 50.0 |
| v | ms⁻¹ | 53.0 | 47.2 | 46.6 |

Quotient

| | | | |
|---|---|---|---|
| I | 2.70 | 2.39 | 2.42 |
| II | 1.18 | 1.04 | 0.88 |
| III | 3.41 | 3.10 | 3.13 |
| III/I | 1.26 | 1.30 | 1.29 |

TABLE 2
Physical-chemical properties

| | | Example | | | | | | | |
|---|---|---|---|---|---|---|---|---|---|
| | | 1 | 2 | 3 | C1 | C2 | C3 | C4 | C5 |
| BET surface area | m²/g | 482 | 496 | 419 | 286 | 381 | 386 | 368 | 364 |
| BJH desorption* | | | | | | | | | |
| cumulative pore volume | cm³/g | 0.81 | 0.84 | 0.52 | 1.02 | 1.34 | 0.69 | 0.73 | 0.68 |
| pore surface area | m²/g | 356 | 370 | 234 | 272 | 354 | 314 | 294 | 285 |
| cumulative | | | | | | | | | |
| mean pore size | nm | 7.1 | 7.1 | 5.7 | 14.3 | 14.2 | 7.3 | 8.2 | 7.8 |
| mean pore diameter | nm | 9.1 | 9.0 | 8.87 | 14.9 | 15.1 | 8.7 | 9.9 | 9.5 |
| (BET × BET)/cumulative | 10⁵ | 2.86 | 2.94 | 3.39 | 0.80 | 1.08 | 2.17 | 1.86 | 1.94 |
| pore volume as per BJH | m/μg | | | | | | | | |
| t-plot | | | | | | | | | |
| micropore volume | cm³/g | 0.035 | 0.034 | 0.066 | 0.013 | 0.025 | 0.016 | 0.009 | 0.013 |
| micropore area | m²/g | 82 | 81 | 149 | 36 | 63 | 44 | 31 | 38 |
| external surface area | m²/g | 400 | 415 | 270 | 250 | 318 | 342 | 338 | 326 |

| primary particle diameter^{&} | | | | | |
|---|---|---|---|---|---|
| median value | nm | 4.4 | 4.9 | 6.3 | n.d. |
| 90% span | nm | 2.91-8.83 | 2.70-9.50 | 3.85-10.60 | n.d. |

*2-50 nm;
^{&}frequency distribution;
n.d. = not determined

1. A silicon dioxide powder in a form of aggregated primary particles, having a specific pore length L of 2.5×10⁵ to 4×10⁵ m/μg, where L is defined as a quotient formed from a square of a BET surface area and a cumulative 2-50 nm pore volume determined by a BJH method, according to the formula L=(BET×BET)/BJH volume.

2. The silicon dioxide powder of claim 1, wherein the BET surface area is from 400 to 600 m²/g.

3. The silicon dioxide powder of claim 1, wherein the cumulative 2-50 nm pore volume determined by a BJH method is from 0.7 to 0.9 cm³/g.

4. The silicon dioxide powder of claim 1, wherein a t-plot micropore volume is from 0.030 to 0.10 cm³/g.

5. A process for producing the silicon dioxide powder of claim 1, the process comprising:
igniting in a burner a gas mixture comprising an oxidizable and/or hydrolyzable silicon compound, hydrogen and an oxygen-comprising gas 1, and burning a resulting flame into a reaction chamber,
introducing an oxygen-comprising gas 2 into the reaction chamber, and
optionally treating an obtained solid material with water vapor and separating the obtained solid material from a gaseous material, wherein
a) in the burner
a quotient I formed from a supplied amount of oxygen and a stoichiometrically required amount of oxygen is from 2 to 4, and
a quotient II formed from a supplied amount of hydrogen and a stoichiometrically required amount of hydrogen is from 0.70 to 1.30, and
an exit velocity v of the gas mixture from the burner is from 10 to 100 ms⁻¹, and
b) in the reaction chamber
a quotient III formed from a total supplied amount of oxygen and a stoichiometrically required amount of oxygen is from 2 to 4, and
the quotient III/quotient I ratio is from 1.1 to 1.5.

6. The process of claim 5, wherein quotient I=2.20 to 3.00, quotient II=0.80 to 0.95, quotient III=2.50 to 3.80, and v=30 to 60 ms⁻¹.

7. The process of claim 5, wherein quotient I=2.20 to 3.00, quotient II=1.00 to 1.30, quotient III=2.50 to 3.80, and v=30 to 60 ms⁻¹.

8. The process of claim 5, wherein the silicon compound is at least one member selected from the group consisting of SiCl₄, CH₃SiCl₃, (CH₃)₂SiCl₂, (CH₃)₃SiCl, HSiCl₃, H₂SiCl₂H₃SiCl(CH₃)₂HSiCl, CH₃C₂H₅SiCl₂, (n-C₃H₇)SiCl₃ and (H₃C)ₓCl₃₋ₓSiSi(CH₃)_{y}Cl_{3-y} where R═CH₃ and x+y=2 to 6 is used.

9. A silanized silicon dioxide powder in a form of aggregated primary particles, having a specific pore length L of 2.5×10⁵ to 3.5×10⁵ m/μg, where L is defined as a quotient formed from a square of a BET surface area and a cumulative 2-50 nm pore volume determined by a BJH method, according to the formula L=(BET×BET)/BJH volume, and wherein a surface area of aggregates or parts thereof is occupied by chemically bound silyl groups.

10. The silicon dioxide powder of claim 9, wherein the BET surface area is from 400 to 550 m²/g.

11. A thermal insulant comprising the silicon dioxide powder of claim 1.

12. A filler in rubber, silicone rubber or a plastic, a rheology modifier in a coating or a paint, a carrier for a catalyst, or a constituent of ink-receiving media, comprising the silicon dioxide powder of claim 1.

13. The silicon dioxide powder of claim 2, wherein the cumulative 2-50 nm pore volume determined by a BJH method is from 0.7 to 0.9 cm³/g.

14. The silicon dioxide powder of claim 2, wherein a t-plot micropore volume is from 0.030 to 0.10 cm³/g.

15. The silicon dioxide powder of claim 3, wherein a t-plot micropore volume is from 0.030 to 0.10 cm³/g.

16. The silicon dioxide powder of claim 13, wherein a t-plot micropore volume is from 0.030 to 0.10 cm³/g.
